(19) United States
(12) Patent Application Publication
(10) Pub. No.: US 2025/0067584 A1
(43) Pub. Date: Feb. 27, 2025

(54) DEVICES, SYSTEMS AND METHODS FOR CAVITATION DETECTION

(71) Applicant: Neptune Technology Group Inc., Tallassee, AL (US)

(72) Inventor: James Davis Garth, Montgomery, AL (US)

(21) Appl. No.: 18/800,318

(22) Filed: Aug. 12, 2024

Related U.S. Application Data
(60) Provisional application No. 63/578,228, filed on Aug. 23, 2023.

(51) Int. Cl. G01F 1/66; G01F 1/667; G01K 11/24

(52) U.S. Cl. CPC G01F 1/662; G01F 1/667; G01K 11/24

(57) ABSTRACT

A device may include a pressure sensor configured to measure water pressure, a communication interface and a processor. The processor may be configured to receive a water pressure measurement from the pressure sensor, determine a water temperature, and determine, based on the water pressure measurement and the water temperature, whether cavitation is occurring or likely to occur in the device. The processor may also transmit, via the communication interface and in response to determining that cavitation is occurring in the device or likely to occur in the device, a signal indicating that cavitation is occurring or likely to occur.

### RELATED APPLICATION

This application claims priority under 35 U.S.C. § 119 based on U.S. Provisional Application No. 63/578,228 filed Aug. 23, 2023, titled “Devices, Systems and Methods for Cavitation,” the disclosure of which is hereby incorporated herein by reference in its entirety.

### BACKGROUND INFORMATION

Cavitation is a phenomenon that occurs when the static pressure in a liquid drops below the vapor pressure, which causes steam bubbles to be generated. The steam bubbles cannot exist outside a low pressure region in which the bubbles were created. For example, once the steam bubbles move to a higher pressure region, the steam bubbles collapse. The collapsing of the steam bubbles can cause problems and/or damage with respect to other parts of a system in which the cavitation occurs.

For example, in a water meter that uses ultrasonic transducers to measure the flow rate of water, cavitation and the collapsing of steam bubbles can impede the movement of sound waves transmitted by the ultrasound transducers. As a result, cavitation can impact the ability of the water meter to obtain accurate measurements with respect to the transmission and reception of the sound waves. This may cause inaccurate meter readings.

### BRIEF DESCRIPTION OF THE DRAWINGS

FIG. 1 illustrates an exemplary environment in which systems and methods described herein may be implemented;

FIG. 2 is a diagram illustrating the meter of FIG. 1 in accordance with an exemplary implementation;

FIG. 3 is a cross-sectional view of the meter of FIG. 2 in accordance with an exemplary implementation;

FIG. 4 is a block diagram of components implemented in one or more of the elements of the environment of FIG. 1 in accordance with an exemplary implementation;

FIG. 5 is a diagram of components included in the meter of FIG. 3 in accordance with an exemplary implementation; and

FIG. 6 is a flow diagram illustrating processing associated with detecting cavitation and providing alerts in accordance with an exemplary implementation.

### DETAILED DESCRIPTION OF EMBODIMENTS

The following detailed description refers to the accompanying drawings. The same reference numbers in different drawings may identify the same or similar elements.

Implementations described herein provide devices, systems and methods for detecting the occurrence and/or likely occurrence of cavitation. For example, water traveling through a water meter may cavitate. In an exemplary implementation, cavitation in the meter may be detected based on the measured water pressure and the determined water temperature in the meter. The pressure and temperature may be compared to a database that provides information regarding when cavitation will occur based on various combinations of pressures and temperatures. If cavitation is occurring or is likely to occur based on the pressure and temperature, the water meter may transmit an alert signal to an entity responsible for monitoring water usage, such as a water company/utility that provides water to customers. The responsible entity may then take various actions with respect to the cavitation, such as ignoring meter readings taken during cavitation, and/or taking actions with respect to mitigating the effects of cavitation.

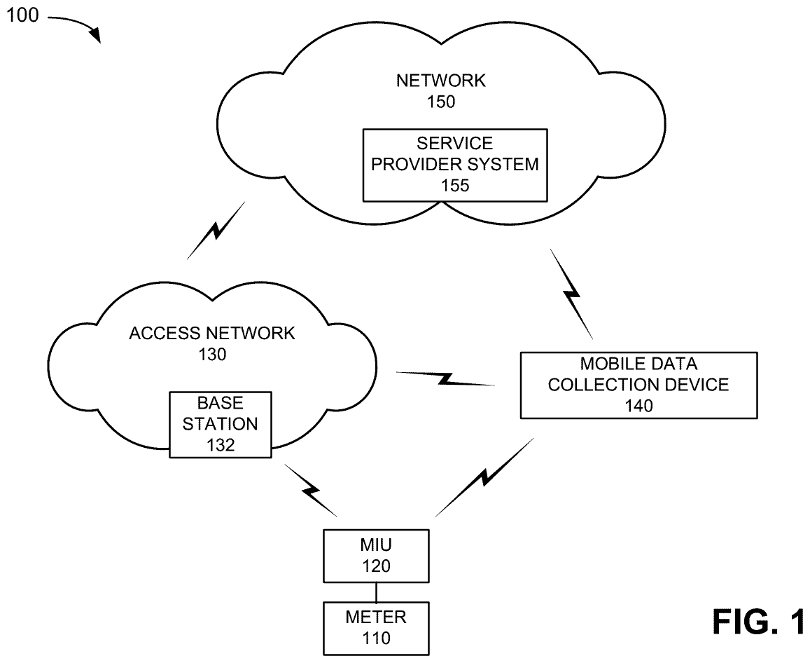

FIG. 1 is a diagram illustrating an exemplary environment 100 in which systems and methods described herein may be implemented. Referring to FIG. 1, environment 100 includes meter 110, meter interface unit (MIU) 120, access network 130, base station 132, mobile data collection device 140, network 150 and service provider system 155.

Meter 110 may include a device configured to measure usage of a resource, such as water, gas, etc. In an exemplary implementation in which meter 110 is a water meter, meter 110 may use different measurement technologies to measure water usage. For example, meter 110 may include an ultrasonic water meter that uses ultrasonic transducers to measure usage of water.

MIU 120 may include a device that collects, analyzes and stores data from meter 110. In one exemplary implementation, MIU 120 may be integrated into meter 110. That is, meter 110 and meter interface unit 120 may be a single component. In other exemplary implementations, MIU 120 or a portion of MIU 120 may be a separate component from meter 110. For example, MIU 120 may be located externally with respect to meter 110 and may be coupled to meter 110 via a wired or wireless connection. MIU 120 may also include one or more wireless transmitters and receivers to provide wireless communication capability for transmitting a current meter reading.

For example, in some implementations, MIU 120 may include cellular communication capability (e.g., a fourth generation long term evolution (4G LTE) wireless communication capability, a fifth generation (5G) wireless communication capability, a sixth generation (6G) wireless communication capability, etc.) to allow MIU 120 to transmit and/or receive data (e.g., transmit the current meter reading, historical/previous meter readings, a meter identifier, consumption flags, etc., and receive instructions/data from a remotely located billing system, etc.). MIU 120 may also include a second wireless communication capability, such as one or more transmitters, receivers and/or transceivers to allow MIU 120 to transmit and/or receive data to/from systems within radio frequency (RF) range of MIU 120 (e.g., a distance ranging from less than 100 feet to over 1-2 miles). For example, when a cellular connection from MIU 120 is experiencing problems, MIU 120 may transmit a current meter reading to mobile data collection device 140 via RF communications, referred to herein as a mobile transmission.

Access network 130 may include a radio access network (RAN) that provides a connection between meter 110, MIU 120 and network 150. For example, access network 130 may be associated with a communication network, such as a 4G LTE network, a 5G network, etc. Access network 130 may include a large number of base stations, with one base station 132 shown for simplicity. Each base station 132 may service a set of user equipment devices that include meter 110 and MIU 120. Base station 132 may connect MIU 120 to access network 130 and network 150 to allow MIU 120 to provide meter reading data to service provider system 155.

In one implementation, base station 132 may include a 4G base station (e.g., an evolved NodeB (eNodeB). In other implementations, base station 132 may include a 5G base station (e.g., a next generation NodeB (gNodeB) or a future generation base station, such as a 6G base station. In each case, base station 132 may include one or more RF transceivers to receive communications from MIU 120 and to communicate with other elements in environment 100, such as service provider system 155.

Mobile data collection device 140 may include a device or system configured to receive and store data from MIU 120. For example, mobile data collection device 140 may be implemented as a mobile or handheld device (e.g., operated by a technician associated with a service provider/utility company, such as a water company), a vehicle mounted device or another mobile device (e.g., a drone). Mobile data collection 140 may be configured to obtain meter data from meter 110 via MIU 120 when a problem occurs with respect to transmitting data to service provider 155 via a cellular connection (e.g., via access network 130 and/or network 150). Mobile data collection device 140 may also be configured to communicate with service provider system 155.

Network 150 may include one or more wired, wireless and/or optical networks that are capable of receiving and transmitting data, voice and/or video signals. For example, network 150 may include one or more public switched telephone networks (PSTNs) or other type of switched network. Network 150 may further include one or more satellite networks, one or more packet switched networks, such as an Internet protocol (IP) based network, a software defined network (SDN), a local area network (LAN), a WiFi network, a Bluetooth network, a wide area network (WAN), a 4G LTE Advanced network, a 5G network, an intranet, or another type of network that is capable of transmitting data. In one implementation, network 150 may provide packet-switched services and wireless Internet protocol (IP) connectivity to various components in environment 100, such as meters 110 and MIUs 120, to allow MIUs 120 to transmit meter reading data to service provider system 155 and other devices/systems.

Service provider system 155 may include one or more devices and/or systems associated with obtaining meter reading data from meter 110. For example, service provider system 155 may include a billing system associated with a utility, such as a water company, gas company, etc. In each case, service provider system 155 may obtain meter data on a periodic basis and bill the customer for resource usage.

The exemplary configuration illustrated in FIG. 1 is provided for simplicity. It should be understood that a typical environment may include more or fewer devices than illustrated in FIG. 1. For example, environment 100 may include a large number (e.g., thousands or more) of meters 110, MIUs 120, base stations 132, mobile data collection devices 140, as well as multiple access networks 130 and service provider systems 155. Environment 100 may also include elements, such as gateways, routers, monitoring devices, network elements/functions, etc. (not shown), that aid in routing data in environment 100.

Various functions are described below as being performed by particular components in environment 100. In other implementations, various functions described as being performed by one device may be performed by another device or multiple other devices, and/or various functions described as being performed by multiple devices may be combined and performed by a single device. For example, as discussed above, in some implementations, meter 110 and MIU 120 may be combined into a single device.

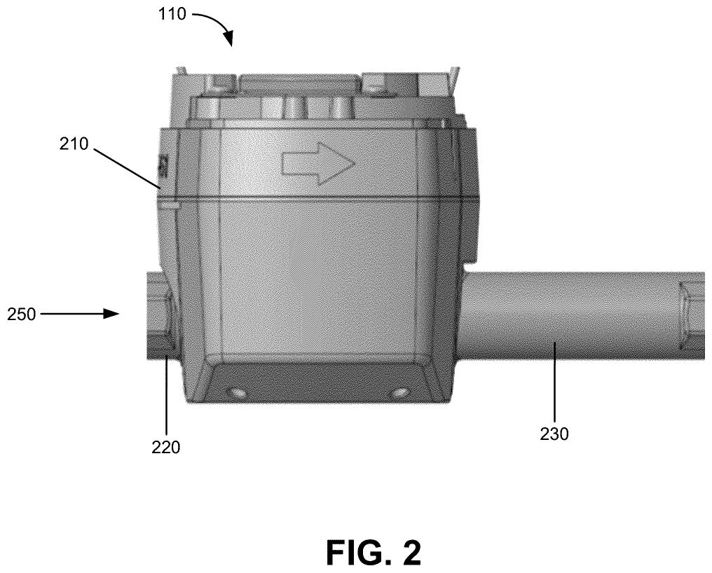

FIG. 2 illustrates an exemplary meter 110. In this implementation, meter 110 may include an external housing 210 coupled to a water supply pipe (not shown) located in an upstream direction with respect to the direction of fluid flow 250 (shown by the arrow in FIG. 2). In an exemplary implementation, meter 110 includes pipe sections referred to herein as a maincase. For example, the maincase of meter 110 may include pipes or pipe sections 220 and 230. In one implementation, pipe 220 may include, for example, a bronze pipe section located in an upstream direction with respect to fluid flow through meter 110, and pipe 230 may include a bronze pipe section 230 located in a downstream direction with respect to fluid flow 250 through meter 110. Pipe 220 may interface with a coupling (not shown), which may be attached to an upstream pipe (not shown) that provides water to, for example, a home or business associated with meter 110, and pipe 230 may interface with a coupling (not shown), which may be attached to a downstream pipe (not shown) that provides water to homes or businesses located in the downstream direction. Housing 210 may house electronics, including one or more processors or processing logic, as well as ultrasonic transducers and other elements used to generate fluid flow measurements. For example, housing 210 may include a measuring channel located adjacent to pipes 220 and 230 and meter 110 may include components to measure the fluid flow through the measuring channel at various intervals, as described in more detail below.

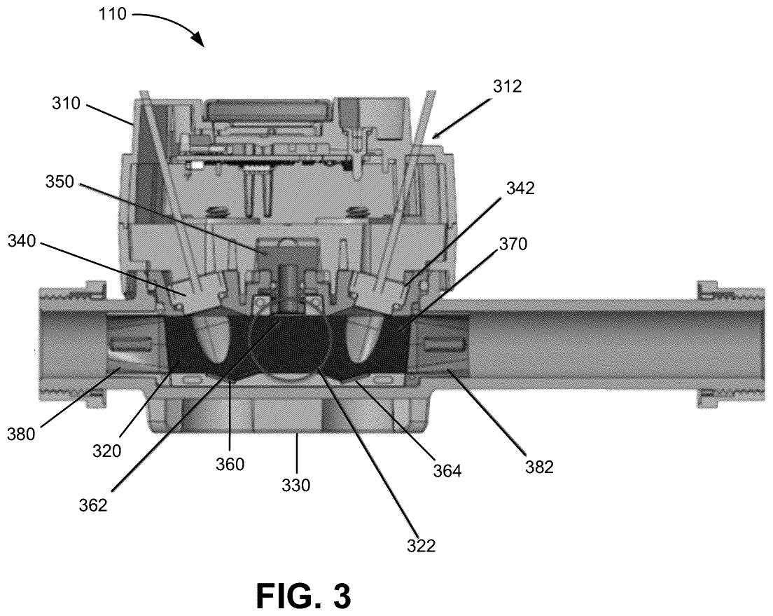

FIG. 3 illustrates a cross-section of meter 110 of FIG. 2 in accordance with an exemplary implementation. Referring to FIG. 3, meter 110 includes upper portion 310, measuring channel 320 in which fluid flows and lower portion 330. Upper portion 310 includes an electronics module or assembly 312, ultrasound transducers 340 and 342 located above measuring channel 320 and pressure sensor 350. In some implementations, upper portion 310 and/or measuring channel 320 may also include a temperature sensor (not shown in FIG. 3) that measures the temperature of water (or another fluid) in measuring channel 320. Electronics module 312 may include one or more processors and/or processing logic the receives measurements from pressure sensor 350 and the temperature sensor (in implementations that include a temperature sensor), as well as measurements associated with the time of flight of ultrasound signals within measuring channel 320, as described below.

For example, measuring channel 320 includes reflective plates 360, 362 and 364. Reflective plates 360, 362 and 364 are located to reflect ultrasound signals generated by ultrasound transducers 340 and 342. For example, ultrasound transducer 340 may transmit an ultrasound signal into measuring channel 320. The ultrasound signal may reflect off reflector 360, travel to reflector 362, reflect off reflector 362, travel to reflector 364, and reflect off reflector 364 to a transducer 342 located in, for example, electronics module 312. Electronics module 312, located in upper portion 310, measures the time of flight of the ultrasound signal in the downstream direction (e.g., from transducer 340 to transducer 342 via measuring channel 320). Similarly, ultrasound transducer 342 may transmit an ultrasound signal into measuring channel 320. The ultrasound signal may reflect off reflector 364 and travel to reflector 362, reflect off reflector 362 and travel to reflector 360, and then reflect off reflector 360 to transducer 340 located in, for example, electronics module 312. Electronics module 312 may measure the time of flight of the ultrasound signal in the opposite direction (e.g., the upstream direction from transducer 342 to transducer 340 via measuring channel 320). The difference in the time of flight between the signal generated by ultrasound transducer 340 and the time of flight for the signal generated by ultrasound transducer 342 may be used to determine the flow rate of fluid through measuring channel 320. For example, the time of flight in the downstream direction (e.g., from ultrasound transducer 340 to ultrasound transducer 342) may be compared to the time of flight in the upstream direction (e.g., from ultrasound transducer 342 to ultrasound transducer 340) to determine the difference. The difference in the time of flight may then be correlated to a fluid velocity measurement value in feet per second or meters per second. Based on the cross-sectional area of measuring channel 320, a flow rate of fluid in gallons per minute or liters per minute may then be determined. In addition, in some implementations, electronics module 312 may calculate the sum of the time of flights of signals transmitted by ultrasound transducers 340 and 342 and use the sum to estimate or impute a temperature of the water flowing through measuring channel 320, as described in detail below.

In accordance with an exemplary implementation, transducers 340 and 342, reflectors 360, 362 and 364, electronics module 312 and other portions of meter 110 defining measuring channel 320 in meter 110 and measuring related components may be referred to as a unitized measuring element (UME). In some implementations, the UME may be an integrated system that may include the measuring related elements and the UME may be inserted into a meter 110 as a single component. In this manner, a new UME may be inserted into meter 110 to replace an existing UME when servicing is required.

Referring to FIG. 3, lower portion 330 of meter 110 includes transition element 380 located in the upstream direction with respect to fluid flow in measuring channel 320. In one implementation, transition element 380 may be included in the maincase and provides a mechanism for attaching electronics module 312 to the maincase. Transition element 380 may also effectively reduce the circular cross-sectional area of pipe 220 (FIG. 2) to a rectangular cross-sectional area. Similarly, lower portion 330 of meter 110 includes transition element 382 located in the downstream direction with respect to measuring channel 320. Transition element 382 effectively increases the rectangular cross-sectional area of measuring channel 320 back to a circular cross-sectional area.

As further illustrated in FIG. 3, pressure sensor 350 may be located in a portion of measuring channel 320 that has a lower water pressure when water is flowing in measuring channel 320. For example, in an exemplary implementation, pressure sensor 350 may be located in region 322, which has the smallest cross-sectional area within measuring channel 320. As a result of this location, when water is flowing in meter 110, the water pressure measured by pressure sensor 350 would be expected to be lower in region 322 than at other areas of the measuring channel that have a larger cross-sectional area. For example, since the velocity of the water may be highest in region 322 having the smallest cross-sectional area, the water pressure in region 322 would be expected to be the lowest in region 322, as compared to the other portions of measuring channel 320.

In implementations in which meter 110 includes a temperature sensor, the temperature sensor may be included in the electronics assembly 312 and/or included within or adjacent to measuring channel 320 may measure the temperature of water flowing through measuring channel 320 at region 322. The combination of pressure and temperature readings may then be used by, for example, electronics module 312, to determine whether cavitation is occurring or likely to occur, as described in more detail below. As described above, in other implementations, meter 110 may not include a temperature sensor. For example, since the speed of sound in water depends on water temperature, in implementations that do not include a temperature sensor, the temperature of the water may be estimated or imputed based on, for example, the time of flight of signals transmitted in meter 110. For example, in one implementation, electronics module 312 may calculate the sum of the downstream time of flight of a signal transmitted by transducer 340 and received by transducer 342 and the upstream time of flight of a signal transmitted by transducer 342 and received by transducer 340. In this implementation, electronics module 312 may store a table of temperature values corresponding to various sums of the times of flight of signals in the upstream and downstream directions. Electronics module 312 may access the table of temperature values and estimate the water temperature based on the sum of the times of flight of the downstream and upstream signals. In either case (i.e., meter 110 includes a temperature sensor or meter 110 does not include a temperature sensor), the water temperature may be obtained and/or determined by electronics assembly 312.

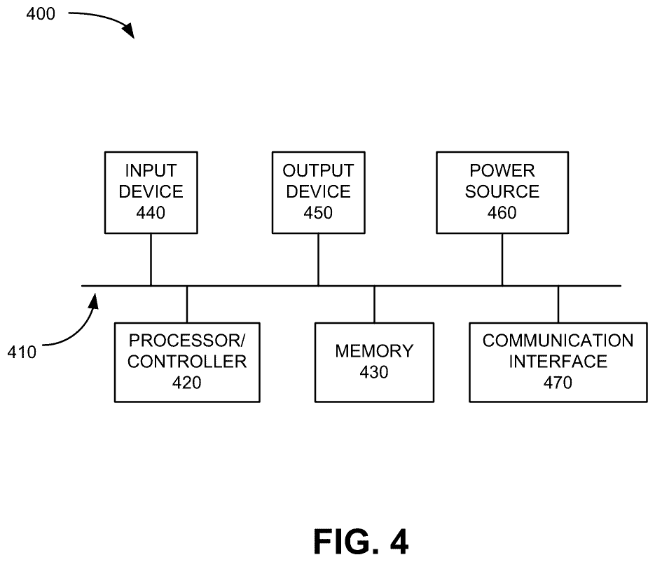

FIG. 4 illustrates an exemplary configuration of a device 400 that may be implemented in environment 100. For example, one or more devices 400 may correspond to or be included in meter 110, the UME of meter 110, MIU 120, base station 132, mobile data collection device 140, service provider system 155 and/or other devices included in environment 100. Referring to FIG. 4, device 400 may include bus 410, processor/controller 420, memory 430, input device 440, output device 450, power source 460 and communication interface 470. The exemplary configuration illustrated in FIG. 4 is provided for simplicity. It should be understood that device 400 may include more or fewer components than illustrated in FIG. 4.

Bus 410 may include a path that permits communication among the elements of device 400. Processor/controller 420 (also referred to herein as processor 420 and/or controller 420) may include one or more processors, microprocessors, or processing logic that may interpret and execute instructions. Memory 430 may include a random access memory (RAM) or another type of dynamic storage device that may store information and instructions for execution by processor 420. Memory 430 may also include a read only memory (ROM) device or another type of static storage device that may store static information and instructions for use by processor 420. Memory 430 may further include a solid state drive (SSD). Memory 430 may also include a magnetic and/or optical recording medium (e.g., a hard disk) and its corresponding drive.

Input device 440 may include a mechanism that permits a user to input information, such as a keypad, a keyboard, a mouse, a pen, a microphone, a touch screen, voice recognition and/or biometric mechanisms, etc. Output device 450 may include a mechanism that outputs information to the user, including a display (e.g., a liquid crystal display (LCD)), a speaker, etc. In some implementations, device 400 may include a touch screen display may act as both an input device 440 and an output device 450. Power source 460 may include a battery or other electrical power source for supplying power to device 400.

Communication interface 470 may include one or more transmitters, receivers and/or transceivers that device 400 uses to communicate with other devices via wired, wireless or optical mechanisms. Communication interface 470 may also include a modem or an Ethernet interface to a LAN or other mechanisms for communicating with elements in a network.

In an exemplary implementation, device 400 performs operations in response to processor 420 executing sequences of instructions contained in a computer-readable medium, such as memory 430. A computer-readable medium may be defined as a physical or logical memory device. The software instructions may be read into memory 430 from another computer-readable medium (e.g., a hard disk drive (HDD), solid state drive (SSD), etc.), or from another device via communication interface 470. Alternatively, hard-wired circuitry may be used in place of or in combination with software instructions to implement processes consistent with the implementations described herein. Thus, implementations described herein are not limited to any specific combination of hardware circuitry and software.

As described above, companies and service providers that provide resources to customers, such as a water company/utility, obtain meter readings on a periodic basis, such as daily, weekly, monthly, etc. In typical situations, meter 110 and/or MIU 120 transmits the meter readings to service provider system 155 via cellular communications. In situations in which access network 130, network 150 and/or meter 110/MIU 120's cellular interface is experiencing a problem, the water utility may use a backup method of obtaining meter reading data that includes deploying in-field mobile data collection device 140 to obtain meter reading data. In either case, meter readings from meter 110 are transmitted to a water company/utility at various intervals.

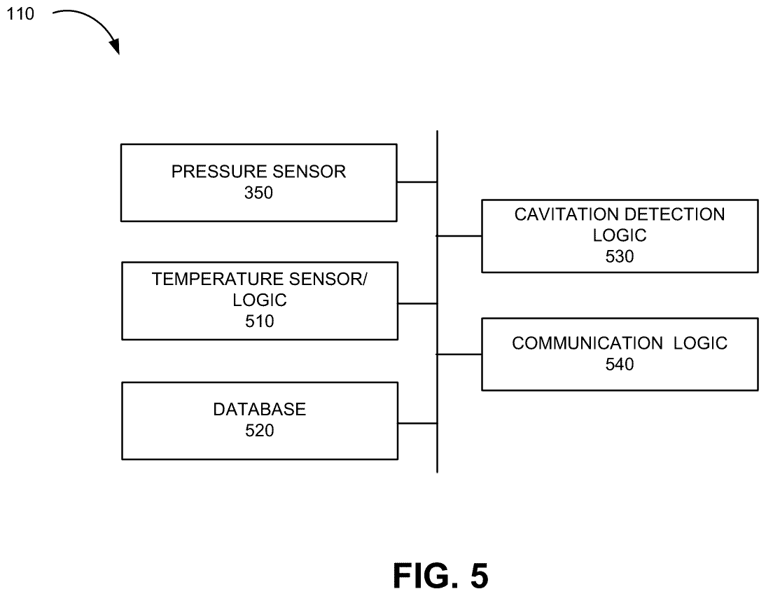

FIG. 5 is a functional block diagram of components implemented in meter 110. Referring to FIG. 5, meter 110 includes pressure sensor 350, temperature sensor/logic 510, database 520, cavitation detection logic 530 and communication logic 540. All of some of these components may be implemented in or interface with electronics module 312, which may include or be implemented by device 400. For example, database 520, cavitation detection logic 530 and communication logic 540 may be implemented by device 400 described above.

Pressure sensor 350, as described above, may measure water pressure in region 322 of measuring channel 320. As also described above, region 322 may have a smaller cross-sectional area than other portions of measuring channel 320. As a result, region 322 may have the lowest water pressure in measuring channel 320. Temperature sensor/logic 510 may obtain the temperature of water in measuring channel 320, such as within region 322. For example, as described above, in some implementations, meter 110 may include a temperature sensor. In such implementations, temperature sensor/logic 510 may measure the water temperature. In implementations in which meter 110 does not include a temperature sensor, electronics module 312 may obtain an estimate of the water temperature based on, for example, the sum of the time of flights of downstream and upstream signals transmitted by transducers 340 and 342, as described above. In either case, electronics assembly 312 may obtain a water temperature value.

Database 520 may include a table of calculated vapor pressures values corresponding to various water temperature values. The calculated vapor pressure values for corresponding temperature values for a fluid such as water are known, such as in steam tables for water. In an exemplary implementation, meter 110 may store such values in database 520 prior to use of meter 110. For example, database 520 may be stored in memory of electronics module 312, such as in a non-volatile memory, ROM, an electrically erasable programmable read only memory (EEPROM), etc. Database 520 may also be implemented in device 400, such as in memory 430 of device 400. In some implementations, database 520 may be implemented externally with respect to meter 110, such as in a discrete component on a printed circuit board (PCB), integrated in a microcontroller and/or microprocessor, stored as a part of firmware or separately as configuration data, etc.

Cavitation detection logic 530 may include one or more processors and/or processing logic that receives pressure values from pressure sensor 350 and temperature values from temperature sensor/logic 510. Cavitation detection 530 may access database 520 and perform a lookup based on the determined temperature to identify the calculated vapor pressure at that particular temperature. Cavitation detection logic 530 may then compare the calculated vapor pressure to the water pressured measured by pressure sensor 350 to determine whether cavitation is occurring or likely to occur. For example, if the determined water pressure is less than the calculated vapor pressure at a particular water temperature, cavitation detection logic 530 may determine that cavitation is occurring or likely occurring. In accordance with an exemplary implementation, if cavitation detection logic 530 determines that cavitation is occurring or likely occurring, cavitation detection logic 530 may generate an alert for transmission to another device, such as service provider system 155.

Communication logic 540 may include logic for communicating with devices in environment 100. For example, communication logic 540 may include one or more devices to transmit data to and receive data from service provider system 155, such as via base station 132, as well as other devices in environment 100 via wired, wireless or optical mechanisms. For example, communication logic 540 may include one or more RF transmitters, receivers and/or transceivers and one or more antennas for transmitting and receiving RF data. Communication logic 540 may also include a modem or an Ethernet interface to a LAN or other mechanisms for communicating with elements in environment 100.

Although FIG. 5 shows exemplary components of meter 110, in other implementations, meter 110 may include fewer components, different components, differently arranged components, or additional components than depicted in FIG. 5. In addition, in some implementation, various functions described as being performed by meter 110 may be performed by other devices located externally with respect to meter 110.

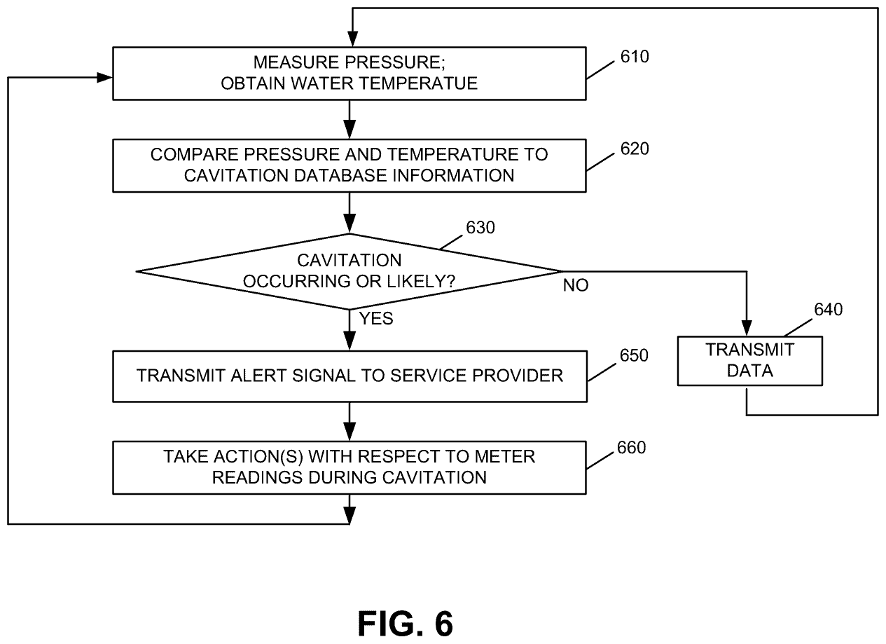

FIG. 6 is a flow diagram illustrating processing associated with environment 100 in accordance with an exemplary implementation. Processing may begin with measuring the water pressure in measuring channel 320 of meter 110 (block 610). For example, pressure sensor 350 may measure the water pressure in region 322 as discussed above. Temperature sensor/logic 510 may also determine the water temperature in region 322 of measuring channel 320 (block 610). For example, as described above, in implementations in which meter 110 includes a temperature sensor, temperature sensor/logic 510 may measure the water temperature. In implementations in which meter 110 does not include a temperature sensor, temperature sensor/logic 510 may estimate the water temperature based on, for example, the time of flight of ultrasound signals through measuring channel 320, as described above. The pressure and temperature readings and/or determinations may be taken every predetermined period of time, such as every second, 10 seconds, one minute, etc. Alternatively, the pressure and temperature readings/determinations may be taken to coincide with when meter readings from meter 110 are to be taken and provided to service provider system 155.

Cavitation detection logic 530 may receive the pressure and temperature values from pressure sensor 350 and temperature sensor/logic 510, respectively. Cavitation detection logic 530 may compare the pressure and temperature values to information stored in database 520 (block 620). For example, cavitation detection logic 530 may perform a lookup in database 520 using the measured/determined temperature to identify the calculated vapor pressure at the measured/determined temperature. Cavitation detection logic 530 may then compare the measured water pressure as measured by pressure sensor 350 in measuring channel 320 to the calculated vapor pressure in database 520 to determine whether cavitation is occurring or likely occurring in meter 110 (block 630). For example, if the measured water pressure is less than the calculated vapor pressure, cavitation detection logic 530 may determine that cavitation is occurring or likely occurring. In addition, if the measured water pressure is not less than the calculated vapor pressure, cavitation detection logic 530 may determine that cavitation is not occurring or not likely occurring.

If cavitation detection logic 530 determines that cavitation is not occurring and/or not likely to occur at the measured water pressure and determined temperature (block 630-no), cavitation detection logic 530 may take no action. Alternatively, cavitation detection logic 530 may signal meter 110 to transmit its meter reading data to, for example, service provider system 155 (block 640). That is, if cavitation is not occurring or not likely occurring, meter reading data determined via electronics module 312 would be expected to be accurate and suitable for billing purposes. Processing may return to block 610 for additional measurements of pressure and temperature at a next time interval.

If, however, cavitation detection logic 530 determines that cavitation is occurring or is likely to occur, at the current measured pressure and temperature pair (block 630—yes), cavitation detection logic 530 may transmit a signal or an alert to, for example, service provider system 155, indicating that cavitation is occurring, or is likely occurring at meter 110 (block 650). As described previously, if cavitation is occurring/likely occurring, service provider system 155 may take various actions with respect to meter readings taken while cavitation is likely occurring (block 660).

For example, if cavitation is likely occurring, signals transmitted by ultrasound transducers 340 and 342 may be impacted by the cavitation and/or the collapsing of the formed steam bubbles in measuring channel 320, resulting in possibly erroneous measurements with respect to the velocity of fluid in measuring channel 320. Therefore, service provider system 155 may modify its estimate of fluid flow, including the option of registering zero flow or interpolating flow between known good readings, while cavitation is occurring. Service provider system 155 may also alert various personnel or an automated system associated with monitoring meters 110, and/or input the measured flow into summary statistics reflecting the state of meter 110 or the state of the water provisioning system. In still other implementations, service provider system 155 may use the alert signals regarding the detection of cavitation to estimate possible damage to or aging of the meter 110 for the purpose of scheduling or managing service or replacement. For example, the cavitation alert signal may be transmitted to a local interface or display, such as an LCD display or an application (app) on a smart device to alert personnel to the cavitation. The interface, display or app may then store information regarding the occurrence of cavitation. The stored information may be used, for example, by a technician servicing meter 110 to determine whether cavitation has occurred recently and/or frequently over a period of time (e.g., seven days, 30 days, etc.). In other implementations, electronics module 312 may not transmit meter readings to service provider system 155 when cavitation is occurring or likely occurring. In still other implementations, service provider system 155 may wait a predetermined period of time after the alert signal is received to use meter readings transmitted by meter 110. In each case, processing may then return to block 610 for additional measurements of pressure and temperature at periodic intervals.

As described above, identifying that cavitation is occurring or likely occurring may be used by a service provider while a meter 110 is being used in the field. In other implementations, identifying cavitation may be used by a service provider prior to a meter 110 being deployed in the field.

For example, when a utility company purchases water meters 110, the utility may test the meters 110 or a portion of the meters 110 to ensure accuracy. While testing a meter 110 in a controlled setting, such as on a test bench or with other test equipment, if cavitation is detected by cavitation detection logic 530, the technician/engineer testing the meter 110 may be alerted in real time to the cavitation by a signal generated by cavitation detection logic 530. As a result, the technician or engineer may adjust one or more test parameters, such as adjust an inlet or outlet valve coupled to the meter 110, increase the water pressure through the meter 110, etc., to ensure that cavitation is not occurring. The technician/engineer may then continue the test and determine whether the meter meets the utility's standards with respect to accuracy regarding the measurement of fluid.

Implementations described herein provide for the detection of cavitation for fluid flowing through a meter. In one implementation, by comparing a current measured water pressure to a calculated vapor pressure of water at a measured temperature, cavitation can be detected. An alert may then be transmitted to an entity managing the meter. This may allow the entity to take one or more actions to mitigate the effects of cavitation.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been described above with respect to detecting cavitation based on pressure readings measured by pressure sensor 350 and temperature values measured or estimated by temperature sensor/logic 510. In other implementations, the pressure measurements may be transmitted to other devices/systems, such as service provider system 155, for other purposes. For example, the service provider/utility providing water to customers may receive the pressure sensor measurements and change one or more parameters associated with the water supply. For example, if the water pressure is consistently very low, the water company/utility may increase the water pressure provided to the customer.

In other instances, the water company may use the measured pressure data to determine whether a measured flow rate is likely to be accurate. For example, if the water pressure measured by pressure sensor 350 is greater than a threshold value, the water company may determine that the measured flow rate generated by meter 110 is likely to be accurate, even if the measured flow rate is particularly high or particularly low. Conversely, if the measured water pressure is below a threshold, the water company may determine that flow rate determined by meter 110 may not be accurate. In this manner, pressure readings from water meter 110 may facilitate additional determinations with respect to usage of the water flow readings generated by meter 110.

In still other implementations, in instances in which low pressure values are common, the water company may determine that a meter 110 needs to be resized. That is, a new meter 110 having a larger size may be needed at a customer location. This may help avoid inaccurate meter readings in the future.

In addition, features have been described above mainly with respect to static water meters, such as ultrasonic meters. It should be understood that features described herein may be used with Coriolis flow meters, electromagnetic flow meters, thermal mass flow meters, turbine meters, etc.

Still further, implementations have been described above mainly with respect to a water meter and measuring water pressure and determining the temperature to detect cavitation in water. In other implementations, other types of fluids and/or gases may be monitored in a similar manner to detect whether cavitation is occurring, and to generate an alert when cavitation is detected, as described above. For example, cavitation may be detected in a similar manner in a gas meter in which gas is flowing.

Further, while series of acts have been described with respect to FIG. 6, the order of the acts may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code-it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A device, comprising:
a pressure sensor configured to measure water pressure;
a communication interface; and
a processor configured to:
receive a water pressure measurement from the pressure sensor,
determine a water temperature,
determine, based on the water pressure measurement and the water temperature, whether cavitation is occurring in the device or likely to occur in the device, and
transmit, via the communication interface and in response to determining that cavitation is occurring in the device or likely to occur in the device, a signal indicating that cavitation is occurring or likely to occur.

2. The device of claim 1, wherein the device comprises a water meter, and when transmitting the signal, the processor is configured to transmit the signal to an entity associated with providing water to customers.

3. The device of claim 2, wherein the processor is further configured to:
ignore meter readings from the water meter in response to detecting that cavitation is occurring or likely to occur.

4. The device of claim 1, wherein the device comprises a water meter, and the pressure sensor is located in a metering channel of the water meter, and
wherein when determining a water temperature, the processor is configured to one of:
receive the water temperature from a temperature sensor included in the water meter, or
estimate the water temperature based on a time of flight of ultrasound signals through a portion of the water meter.

5. The device of claim 4, wherein the metering channel has a first cross-sectional area at an input side of the metering channel, and second cross-sectional area at a location associated with the pressure sensor, wherein the first cross-sectional area is greater than the second cross-sectional area.

6. The device of claim 1, further comprising:
a database configured to store information identifying a plurality of vapor pressure values corresponding to a plurality of temperature values.

7. The device of claim 6, wherein when determining whether cavitation is occurring or likely to occur, the processor is configured to:
access the database and perform a lookup using the determined water temperature,
identify one of the plurality of vapor pressure values corresponding to the water temperature,
compare the water pressure measurement to the identified vapor pressure value, and
determine that cavitation is occurring or likely to occur when the water pressure measurement is less than the identified vapor pressure value.

8. The device of claim 1, wherein the device comprises a water meter, and the processor is further configured to:
wait a predetermined period of time prior to generating a meter reading, in response to determining that cavitation is occurring in the device or likely to occur in the device.

9. The device of claim 1, wherein the device comprises a water meter and the processor is further configured to:
transmit the water pressure measurement to a service provider associated with monitoring the water meter.

10. The device of claim 9, wherein the water pressure measurement is used by the service provider to adjust a system parameter associated with the device.

11. A method, comprising:
measuring, in a water meter, water pressure;
determining, in the water meter, a temperature of the water;
determining, based on the measured water pressure and the temperature, whether cavitation is occurring or likely to occur in the water meter; and
transmitting, in response to determining that cavitation is occurring in the water meter or likely to occur in the water meter, a signal indicating that cavitation is occurring or likely to occur.

12. The method of claim 11, wherein the transmitting comprises:
transmitting the signal to a water utility associated with the water meter.

13. The method of claim 12, further comprising:
ignoring meter readings from the water meter in response to detecting that cavitation is occurring or likely to occur.

14. The method of claim 11, wherein the water meter includes a metering channel and measuring the water pressure comprises:
measuring the water pressure at a location of the metering channel that has a smaller cross-sectional area than an input side of the metering channel.

15. The method of claim 11, wherein the determining whether cavitation is occurring or likely to occur comprises:
accessing a database configured to store information identifying a plurality of vapor pressure values corresponding to a plurality of temperature values,
perform a lookup in the database using the determined water temperature,
identify one of the plurality of vapor pressure values corresponding to the water temperature,
compare the measured water pressure to the identified vapor pressure value, and
determine that cavitation is occurring or likely to occur when the measured water pressure is less than the identified vapor pressure value.

16. The method of claim 11, furthering comprising:
waiting a predetermined period of time prior to generating a meter reading, in response to determining that cavitation is occurring in the water meter or likely to occur in the water meter.

17. The method of claim 11, further comprising:
transmitting the measured water pressure to a service provider associated with monitoring the water meter.

18. The method of claim 17, further comprising:
adjusting a parameter of the water meter based on the measured water pressure.

19. A non-transitory computer-readable medium having stored thereon sequences of instructions which, when executed by at least one processor included in a device, cause the at least one processor to:
receive a water pressure measurement from a pressure sensor;
determine a water temperature;
determine, based on the water pressure measurement and water temperature, whether cavitation is occurring or likely to occur; and
transmit, via a communication interface and in response to determining that cavitation is occurring in the device or likely to occur in the device, a signal indicating that cavitation is occurring or likely to occur.

20. The non-transitory computer-readable medium of claim 19, wherein when determining whether cavitation is occurring or likely to occur, the instructions cause the at least one processor to:
access a database a configured to store information identifying a plurality of vapor pressure values corresponding to a plurality of temperature values,
perform a lookup in the database using the determined water temperature,
identify one of the plurality of vapor pressure values corresponding to the water temperature,
compare the water pressure measurement to the identified vapor pressure value, and
determine that cavitation is occurring or likely to occur when the water pressure measurement is less than the identified vapor pressure value.
